(19) United States
(12) Patent Application Publication
(10) Pub. No.: US 2009/0185754 A1
(43) Pub. Date: Jul. 23, 2009

(54) IMAGE PROCESSING CIRCUIT AND IMAGE PROCESSING APPARATUS

(75) Inventor: Yukio Okamura, Shojirishi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/351,750

(22) Filed: Jan. 9, 2009

(30) Foreign Application Priority Data
Jan. 10, 2008 (JP) 2008-002922

(51) Int. Cl. G06K 9/40; G06K 9/20

(52) U.S. Cl. 382/261; 382/312

(57) ABSTRACT

There is provided an image processing circuit to which a block image obtained by cutting an area corresponding to a predetermined main scanning width and a predetermined sub-scanning width from an original image is input and which performs filter processing on each of pixels constituting the block image to be output. The image processing circuit includes: a memory which arranges each of segments in each of pixel rows in a sub-scanning direction and stores the block image, the segment being formed such that a bit width is a width equal to or larger than a main scanning width of a filter, a storage capacity is at least a double of a sub-scanning width of the filter, and each of the pixel rows of the block image is divided into the bit widths; a reading unit which reads pixel data as a filter processing target from the memory in a segment unit and outputs the pixel data; a filter processing unit which includes multipliers, which multiply the pixel data output by the reading unit and a predetermined filter coefficient corresponding to a pixel location of the pixel data, of the number corresponding to the main scanning width of the filter and which performs the filter processing by performing multiplication and addition calculations to output pixel data of a notice pixel; and a register which temporarily stores the pixel data read by the reading unit. The reading unit determines whether the pixel data as the filter processing target are all contained in one segment. When the pixel data as the filter processing target are all contained in the one pixel, the reading unit reads and outputs the pixel data of the segment. When the pixel data as the filter processing target are contained in two segments, the reading unit reads the pixel data of one of the two segments to stores the pixel data in the resistor and reads the pixel data of the other thereof together with the pixel data stored in the register to output the pixel data to the filter processing unit.

The entire disclosure of Japanese Patent Application No. 2008-002922, filed Jan. 10, 2008, is expressly incorporated by reference herein.

### BACKGROUND

1. Technical Field

The present invention relates to an image processing circuit and an image processing apparatus, and particularly to a technique capable of performing a filter calculation on an image in a block unit.

2. Related Art

As one of methods of performing image processing such as filter calculation on an original image (for example, image data corresponding to one page) stored in an image memory such as a RAM (Random Access Memory) in image processing apparatuses such as printers, image scanners, or copiers, there is known a method (hereinafter, referred to as “a block process”) of performing the filter calculation on every image data of the original image in a unit called a block (JP-A-2001-251502).

In an image processing circuit disclosed in JP-A-2001-251502, pixel data which constitute a block image cut from an original image stored in a RAM are stored in a register to perform the filter calculation on the pixel data output from the register. In the block process, a circuit controlling process or a circuit configuration is simplified, when a storage unit (hereinafter, referred to as “a block memory”) used to store the pixel data constituting the block image is configured by a register. However, the register has a problem in that the power consumption and the gate size of the register are larger than those of a SRAM (Static Random Access Memory). In order to solve this problem, using the SRAM as the block memory may be taken into consideration.

However, when the SRAM is used as the block memory, there is a disadvantage that one additional clock is necessary upon reading the pixel data, compared to the register. Therefore, it is necessary for a calculation speed of filter processing not to be decreased.

### SUMMARY

An advantage of some aspects of the invention is that it provides a technique capable of reducing power consumption and the circuit size of an image processing circuit and performing a filter calculation at a high speed in the image processing circuit performing the filter calculation.

According to an aspect of the invention, there is provided an image processing circuit to which a block image obtained by cutting an area corresponding to a predetermined main scanning width and a predetermined sub-scanning width from an original image is input and which performs filter processing on each of pixels constituting the block image to be output. The image processing circuit includes: a memory which arranges each of segments in each of pixel rows in a sub-scanning direction and stores the block image, the segment being formed such that a bit width is a width equal to or larger than a main scanning width of a filter, a storage capacity is at least a double of a sub-scanning width of the filter, and each of the pixel rows of the block image is divided into the bit widths; a reading unit which reads pixel data as a filter processing target from the memory in a segment unit and outputs the pixel data; a filter processing unit which includes multipliers, which multiply the pixel data output by the reading unit and a predetermined filter coefficient corresponding to a pixel location of the pixel data, of the number corresponding to the main scanning width of the filter and which performs the filter processing by performing multiplication and addition calculations to output pixel data of a notice pixel; and a register which temporarily stores the pixel data read by the reading unit. The reading unit determines whether the pixel data as the filter processing target are all contained in one segment. When the pixel data as the filter processing target are all contained in the one pixel, the reading unit reads and outputs the pixel data of the segment. When the pixel data as the filter processing target are contained in two segments, the reading unit reads the pixel data of one of the two segments to stores the pixel data in the resistor and reads the pixel data of the other thereof together with the pixel data stored in the register to output the pixel data to the filter processing unit.

In the image processing circuit according to this aspect of the invention, the memory, the reading unit, the register may be provided for each of RGB colors and one filter processing unit may be provided.

In the image processing circuit according to this aspect of the invention, a monochrome block image may be stored in the memory of one color. In addition, the reading unit of the memory may store a copy of the image data output to the filter processing unit in a register other than the register used by the reading unit, and may read the pixel data from the register to output the read pixel data, when the pixel data is the filter processing target.

In the image processing circuit according to this aspect of the invention, the memory may be configured by a SRAM.

According to another aspect of the invention, there is provided an image processing apparatus including the image processing circuit.

### BRIEF DESCRIPTION OF THE DRAWINGS

The invention will be described with reference to the accompanying drawings, wherein like numbers reference like elements.

FIG. 1 is a diagram for explaining a processing sequence of notice pixels in a block process.

FIGS. 2A to 2D are diagrams for explaining a method of storing a block image in a block memory.

FIG. 3 is a diagram for explaining a filter calculation method of the notice pixels in ends of an original image.

FIGS. 4A to 4C are diagrams for explaining the filter calculation method using a block memory.

FIG. 5 is a block diagram illustrating the overall configuration of an image processing circuit according to a first embodiment.

FIG. 6 is a block diagram illustrating the overall configuration of a filter calculation circuit.

FIGS. 7A to 7C are diagrams for explaining a method of extracting pixel data input to the filter calculation circuit.

FIGS. 8A and 8B are timing charts illustrating operations of the image processing circuit according to the first embodiment.

FIG. 9 is a flowchart illustrating a sequence of the block process.

FIG. 10 is a block diagram illustrating the overall configuration of an image processing circuit according to a second embodiment.

FIGS. 11A and 11B are timing charts illustrating operations of the image processing circuit according to the second embodiment.

### DESCRIPTION OF EXEMPLARY EMBODIMENTS

Hereinafter, a first embodiment of the invention will be described with reference to the drawings.

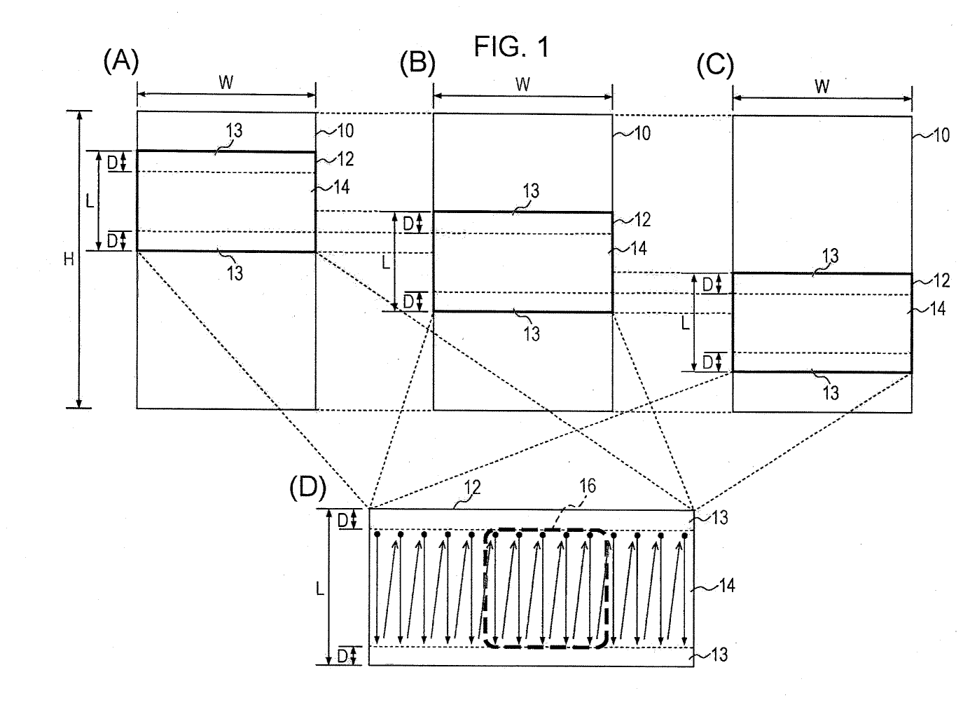

First, an overview of a block process performed according to this embodiment will be described with reference to FIGS. 1 to 3 and FIGS. 4A to 4C.

FIG. 1 is a diagram for explaining a processing sequence of pixels (hereinafter, referred to as “notice pixels”) which are a target for obtaining a result (hereinafter, referred to as “output pixel data”) of a filter calculation.

As shown in (A) to (C) of FIG. 1, an original image 10 is an image corresponding to one page having a height and a length, and an area of a main scanning width W (unit: pixel) and a sub-scanning width H (unit: pixel). As shown in (D) of FIG. 1, the filter calculation is performed on pixels contained in an area 14 (which has the main scanning width W and a sub-scanning width L-2D) of a predetermined area 12 (which has the main scanning width W and a sub-scanning width L) in the original image 10. As for the processing sequence of the notice pixels, they are processed in each row vertically in the sub-scanning direction until the final row is reached and processed. After the last pixel in the last row, the process starts again from the next adjacent column of pixels starting from top to bottom of the scanning area. That is, the vertical sub-scanning direction has priority over the horizontal main scanning direction

Since the filter calculation needs to be performed on the entire pixels of the original image 10, the area 12 is moved along the length of the original image and so as to overlap by a sub-scanning width 2D, as shown in a transition from (A) to (C) of FIG. 1. An area 13 (which has the main scanning width W and a sub-scanning width D) is an area containing pixels necessary to perform the filter calculation on the notice pixels in the upper and lower portion of the area 14. As described below, the original image 10 is stored in an image memory such as a SDRAM (Synchronous DRAM) or a DDR-SDRAM (Double Data Rate SDRAM) which has a large capacity. In addition, the filter calculation is performed on a block image 16 which is obtained from the original image 10 and stored in a block memory such as a SRAM.

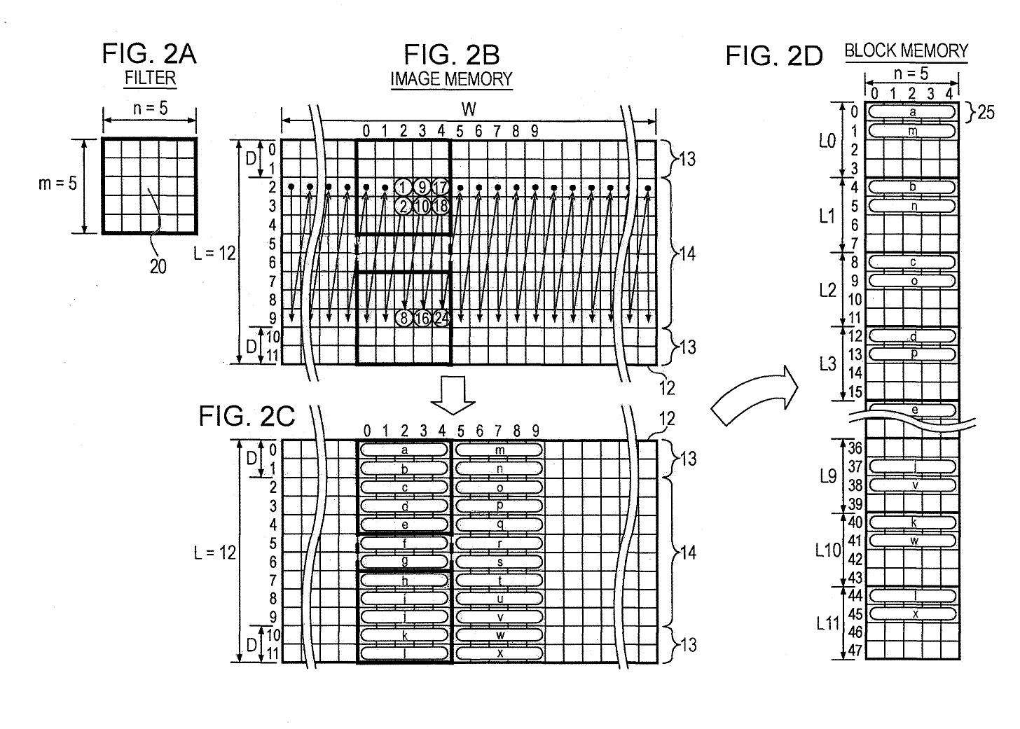

FIGS. 2A to 2D are diagrams for explaining a method of storing the block image in the block memory. FIG. 2A shows the configuration of a filter. FIGS. 2B and 2C show the area 12 (see FIG. 1) in the original image 10 in detail. FIG. 2D shows the configuration of the block memory. Hereinafter, an example in which the filter calculation is performed using a five-pixel filter having a main scanning width n and a sub-scanning width m will be described.

As shown in FIG. 2A, a notice pixel 20 is located at the center of the filter. The output pixel data of the notice pixel 20 is calculated by a known filter calculation method which uses multiplication, addition, and division operations. Specifically, there is a filter coefficient at each of pixel locations of the filter. In addition, the output pixel data of the notice pixel 20 is obtained by multiplying each of pixel data, which is a filter calculation target, by each of the filter coefficients of locations corresponding to locations of the pixel data and dividing an added value of the multiplied results by a predetermined value.

When a sub-scanning width m of the filter is equal to five pixels, pixels corresponding to two rows in each of upper and lower rows of a row where the notice pixel is located are necessary in order to perform the filter calculation. Therefore, the sub-scanning width D of the area 13 is two pixels. The sub-scanning width D is able to be calculated with an expression of “(sub-scanning width m of filter−1)/2”. For example, when the sub-scanning width m of the filter is equal to seven pixels, the sub-scanning width D is equal to three pixels. The sub-scanning width L of the area 12 is equal at least to the sub-scanning width m of the filter. However, it is better that a difference between m and L is larger in consideration of calculation efficiency in the number of copies of the block image to the block memory or the like. That is, since a value of the sub-scanning width D is uniform, more numerous notice pixels are able to be processed by copying the block image in which a value of a sub-scanning width (L-2D) is larger to the block memory and using the block memory.

When the filter calculation is performed using the above-described filter in succession from notice pixel 1 (main scanning location 2, sub-scanning location 2), as in FIG. 2B, each of the pixel data of pixel groups a to x is copied at each corresponding location of the block memory, as in FIG. 2C. The block memory is configured so that a bit width (main scanning width) is equal to the main scanning width n, for example, as in FIG. 2D. In addition, a segment 25 (main scanning width n, sub-scanning width 1) is configured as a storage capacity which is arranged in four rows of each of pixel rows (lines) L0 to L11. Accordingly, the pixel data corresponding to the maximum four segments are stored in every pixel row L in the block memory.

The bit width (main scanning width) of the block memory is at least a width equal to or larger than the main scanning width n of the filter. In addition, the storage capacity of the block memory (in sub-scanning direction) is at least a double (2 or more segments in every pixel line L) of the sub-scanning width L. Since reading and writing the pixel data from and to the block memory are performed in a segment unit, access competition is not necessary, thereby realizing a parallel process. That is, the filter calculation described below allows the parallel process to be performed on the segments subjected to the reading of the pixel data by copying new pixel data from the original image and storing the copied pixel data during reading the pixel data of other segments.

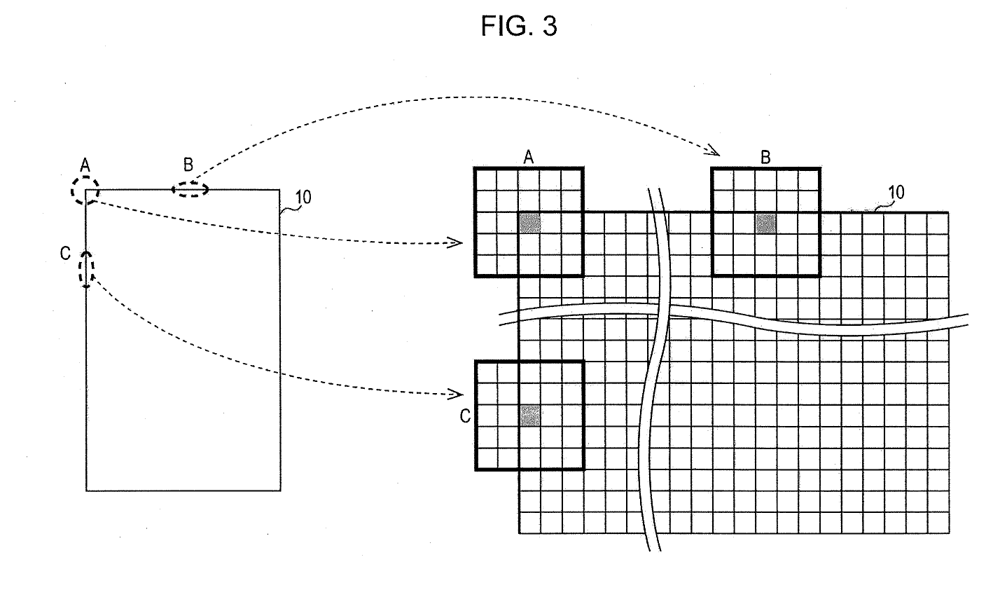

As shown in FIG. 3, upon performing the filter calculation on the pixels in the upper, lower, right, and left ends (for example, locations of A, B, and C) of the original image 10, areas which are located outside the original image 10 and have no pixel data are contained in the scope of the filter calculation target. In this case, the areas which have no pixel data are handled like an area which has the pixel data. For example, the pixel data indicated by a white color or copies of the pixel data in the upper, lower, right, and the left ends of the original image 10 are stored in the block memory. In this way, by storing dummy pixel data in the block memory, it is possible to perform the filter calculation irrespective of the location of the notice pixel.

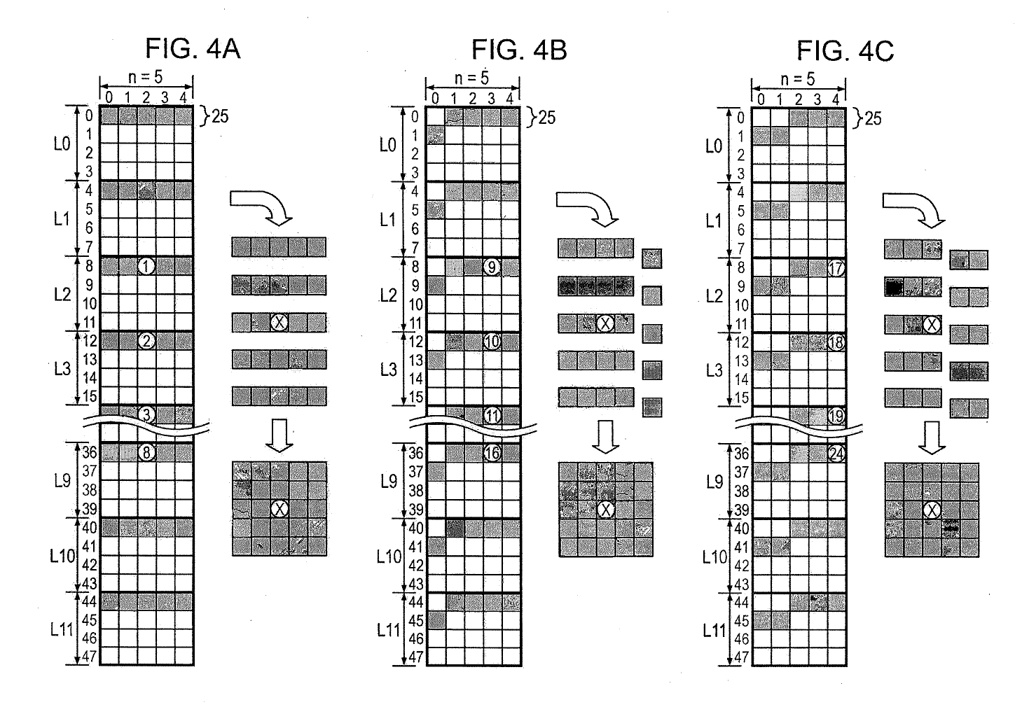

As shown in FIGS. 4A to 4C, the filter calculation is performed upon storing the block image in the block memory in this manner. In addition, notice pixel numbers 1 to 24 shown in FIGS. 4A to 4C correspond to the notice pixel numbers 1 to 24 of FIG. 2B.

FIG. 4A shows that the filter calculation is performed on notice pixel 1 (main scanning location 2, sub-scanning location 8) to notice pixel 8 (main scanning location 2, sub-scanning location 36). The output pixel data of the notice pixel 1 is obtained by reading the pixel data of segments 0, 4, 8, 12, and 16 in order, performing multiplication and addition operations with the filter coefficients of the locations corresponding to the locations of the pixel data contained in each segment, and dividing the result by a predetermined value. In order to obtain the output pixel data of notice pixel 2 (main scanning location 2, sub-scanning location 12), the pixel data of segments 4, 8, 12, 16, and 20 are read. Likewise, in order to obtain the output pixel data of the notice pixel 8, the pixel data of segments 28, 32, 36, 40, and 44 are read, after shifting by four segments in the sub-scanning direction.

FIG. 4B shows that the filter calculation is performed on notice pixel 9 (main scanning location 3, sub-scanning location 8) to notice pixel 16 (main scanning location 3, sub-scanning location 36). In order to obtain the output pixel data of the notice pixel 9, the pixel data of the segments 0 and 1, segments 4 and 5, the segments 8 and 9, the segments 12 and 13, and the segments 16 and 17 are read in order. Subsequently, the pixel data of the main scanning locations 1 to 4 of the first segments in the pairs of segments and the pixel data of the main scanning location 0 of the second segment are extracted. In addition, the pixel data of the main scanning location 1 of the first segment is at the head and the pixel data of the main scanning location 0 of the second segment is at the end so as to arrange the pixel data of one segment. Subsequently, the output pixel data of the notice pixel 9 is obtained by performing the multiplication and addition operations with the filter coefficients corresponding to the locations of the pixel data after the arrangement and dividing the result of the multiplication and addition operations. In order to obtain the output pixel data (main scanning location 3, sub-scanning location 12) of notice pixel 10, the pixel data of the segments 4 and 5, the segments 8 and 9, the segments 12 and 13, the segments 16 and 17, and segments 20 and 21 are read. Likewise, in order to obtain the output pixel data of the notice pixel 16, the pixel data of segments 28 and 29, segments 32 and 33, segments 36 and 37, segments 40 and 41, and segments 44 and 45 are read, after shifting by four segments in the sub-scanning direction.

FIG. 4C shows that the filter calculation is performed on notice Pixel 17 (main scanning location 4, sub-scanning location 8) to notice Pixel 24 (main scanning location 4, sub-scanning location 36). In order to obtain the output pixel data of the notice pixel 17, the pixel data of the segments 0 and 1, the segments 4 and 5, the segments 8 and 9, the segments 12 and 13, and the segments 16 and 17 are read in order. Subsequently, the pixel data of the main scanning locations 2 to 4 of the first segments in the pairs of segments and the pixel data of the main scanning locations 0 and 1 of the second segment are extracted. In addition, the pixel data of the main scanning location 2 of the first segment is at the head and the pixel data of the main scanning location 1 of the second segment is at the end so as to arrange the pixel data of one segment. Subsequently, the output pixel data of the notice pixel 17 is obtained by performing the multiplication and addition operations with the filter coefficients corresponding to the locations of the pixel data and dividing the result of the multiplication and addition operations by a predetermined value. In order to obtain the output pixel data (main scanning location 4, sub-scanning location 12) of notice pixel 18, the pixel data of the segments 4 and 5, the segments 8 and 9, the segments 12 and 13, the segments 16 and 17, and segments 20 and 21 are read. Likewise, in order to obtain the output pixel data of the notice pixel 24, the pixel data of segments 28 and 29, segments 32 and 33, segments 36 and 37, segments 40 and 41, and segments 44 and 45 are read, after shifting by four segments in the sub-scanning direction.

The overview of the block process performed according to this embodiment has been described.

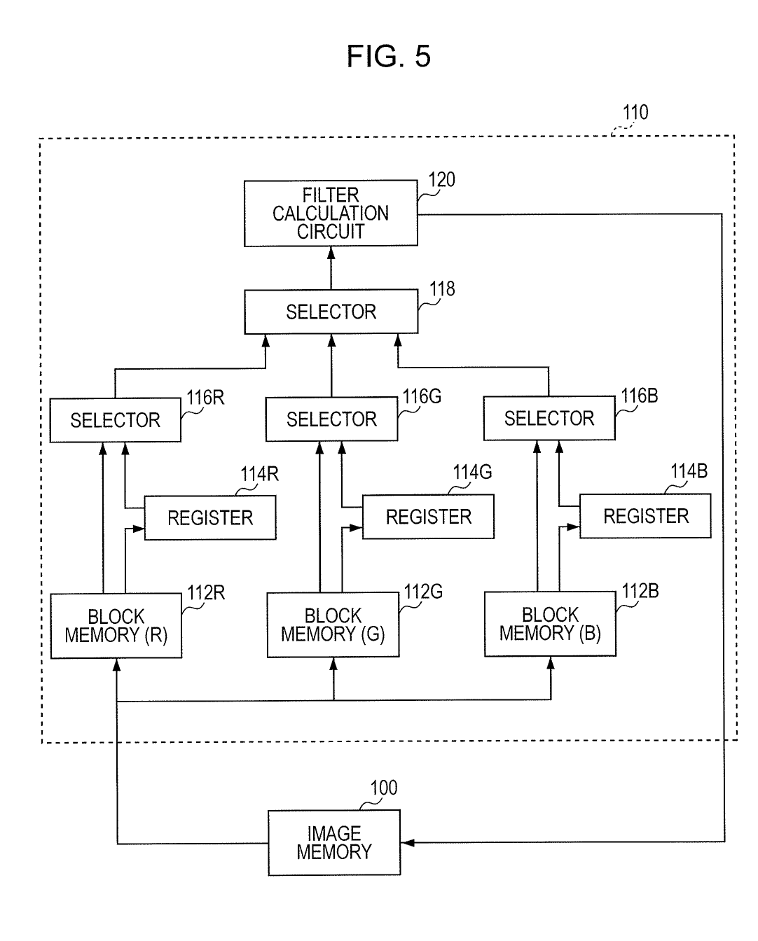

Next, an image processing circuit which performs the block process described above will be described. FIG. 5 is a block diagram illustrating the overall configuration of the image processing circuit according to this embodiment.

As shown in FIG. 5, an image processing circuit 110 is connected to an image memory 100. The image memory 100 is used to store original image data and image data subjected to the filter calculation. The image memory 100 is configured by a memory such as a SDRAM (Synchronous DRAM) or a DDR-SDRAM (Double Data Rate SDRAM) which has a large capacity.

The image processing circuit 110 which is an exclusive circuit designed and manufactured to perform the above-described block process is realized by an ASIC (Application Specific Integrated Circuit), for example. The image processing circuit 110 includes a block memory 112, a resistor 114, a selector 116, a selector 118, a filter calculation circuit 120, and signal wires which connects these constituent elements. The block memory 112, the register 114, and the selector 116 are provided for each of the colors in the RGB color model.

The block memory 112 is used to store the block image obtained from the original image data of the image memory 100. The block memory 112 is configured by the SRAM, for example, and may be configured by a dual-port RAM. As described above, the bit width (main scanning width) of the block memory 112 is a width equal to or larger than the main scanning width n of the filter, and the storage capacity (sub-scanning width) is at least a double of the sub-scanning width L of the block image. Here, description will be made with the same configuration as that in FIG. 2D. In addition, plane image data of respective colors are stored in block memories 112R, 112G, and 112B for each of the colors in the RGB color model, respectively.

The register 114 is used to temporarily store the pixel data of the segments read from the block memory 112. As described below, the register 114 is used when the pixel data, which is a filter calculation target, are located over two segments. The register 114 has a capacity of storing pixel data corresponding to at least one segment.

The selector 116 reads the pixel data from the block memory 112 or the register 114 in a segment unit. In addition, the pixel data which are the filter calculation target are extracted from the read pixel data, the pixel data are arranged in right order, and the pixel data are output to the filter calculation circuit 120 through the selector 118.

The selector 118 selects one of the respective selectors 116R, 116G, and 116B of the RGB colors. In addition, the pixel data of the segment unit received from the selected selector 116 is output to the filter calculating circuit 120.

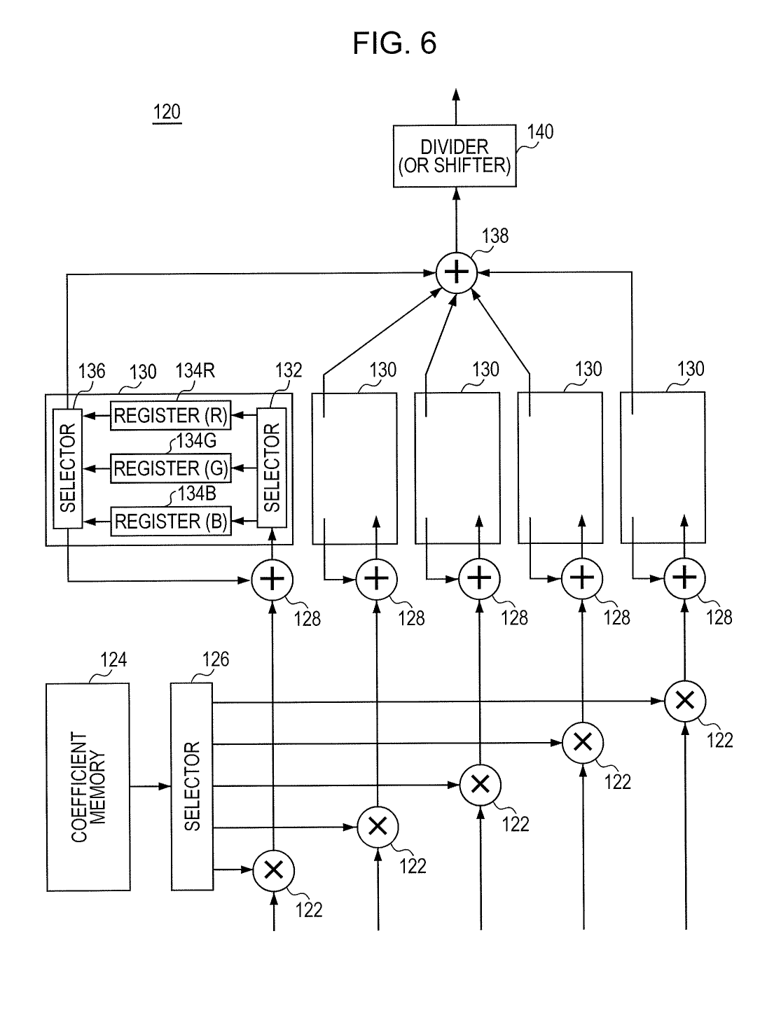

The filter calculation filter 120 is a circuit which performs multiplication and addition operations using the input pixel data and the filter coefficients and performs a division operation on the result of the multiplication and addition operations to output the output pixel data of each notice pixel. Specifically, the filter calculation circuit 120 is configured as in FIG. 6. In addition, the filter calculation circuit 120 is shared for the RGB colors.

FIG. 6 is a block diagram illustrating the overall configuration of the filter calculation circuit 120. As shown in FIG. 6, the filter calculation circuit 120 includes multipliers 122, a coefficient memory 124, a selector 126, adders 128, register groups 130 (a selector 132, registers 134, and a selector 136), an adder 138, a divider 140, and signal wires which connects these constituent elements.

Each of the multipliers 122 multiplies the pixel data input from the selector 118 by the filter coefficient input from the coefficient memory 124 through the selector 126, and outputs the multiplied result to each of the adders 128. The number of multipliers 122 is the same as the number of the sub-scanning width n of the filter.

The selector 126 reads the filter coefficients of the locations on the filter corresponding to the pixel data input to the multipliers 122 from the coefficient memory 124 and outputs the read filter coefficients to the multipliers 122.

The coefficient memory 124 stores the filter coefficient in each pixel location within the filter.

Each of the adders 128 adds the data output by each of the multipliers 128 and data (the result of the multiplication and addition operations before one) of the register 134 output by the selector 136 and outputs the addition data to the selector 132.

The selector 132 outputs the data output by the adder 128 to one of the respective registers 134R, 134G, and 134B of the RGB colors.

The register 134 is provided for the respective RGB colors and holds the result of the multiplication and addition operations on the pixels in the sub-scanning direction.

The selector 136 reads data from one of the registers 134R, 134G, and 134B and outputs one of the adder 128 and the adder 138. When the results of the multiplication and addition operations which correspond to the sub-scanning width m of the filter are held in the register 134, data regarding to the results are output to the adder 138. Alternatively, when the results thereof are not held, the data regarding the results are output to the adder 128.

The adder 138 adds all the results of the multiplication and addition operations of the registers 134 output from the n selectors 136 and outputs the added result to the divider 140.

The divider 140 divides the result of the multiplication and addition operations of all the pixels within the filter which is output from the adder 138 by a predetermined value to calculate the output pixel data of the notice pixel. Subsequently, the output pixel data is output to the image memory 100. Of course, a shifter may be provided instead of the divider 140.

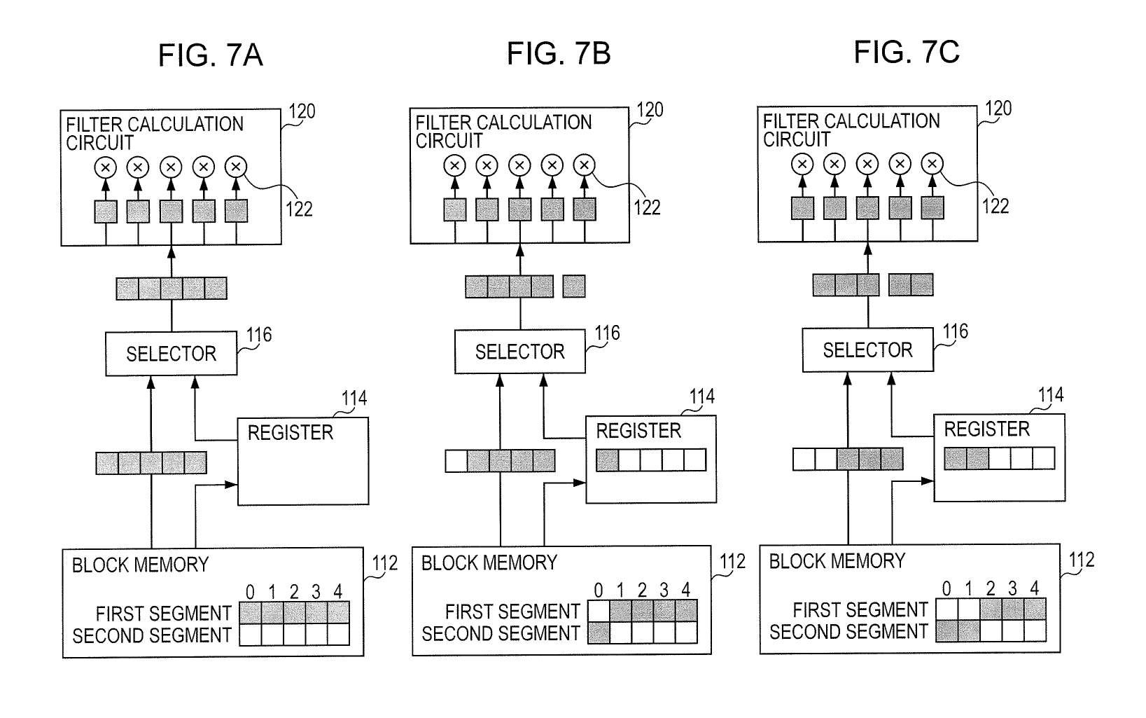

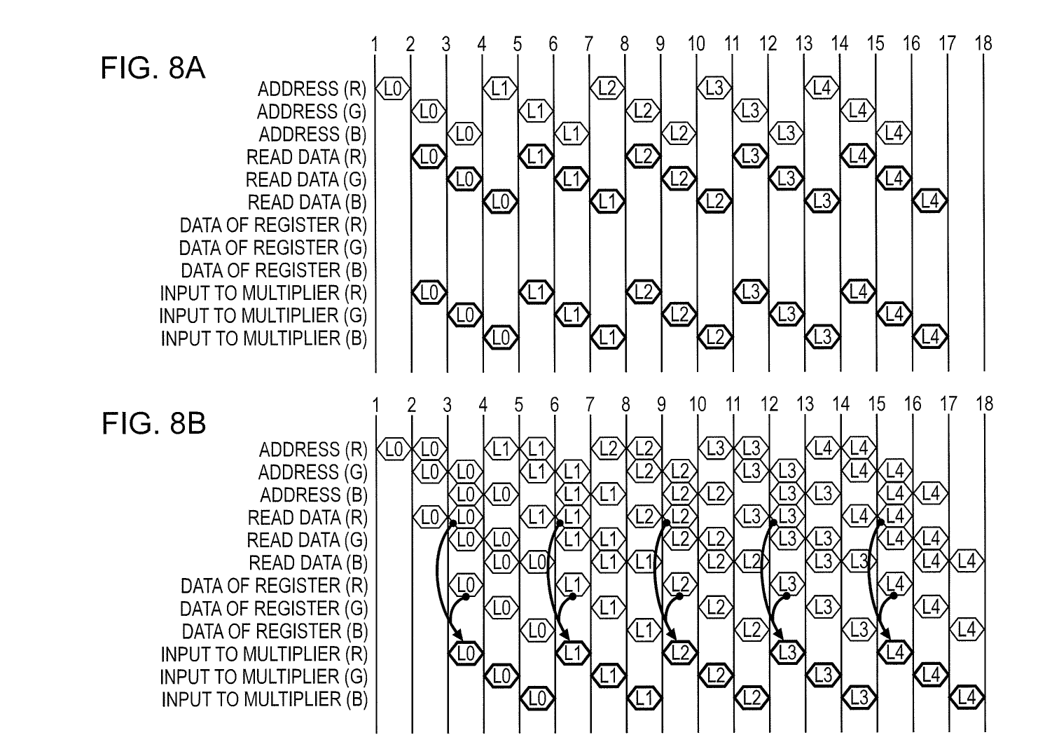

Next, characteristic operations of the image processing circuit 110 will be described with reference to FIGS. 4A to 4C, 7A to 7C and 8A and 8B. FIGS. 7A to 7C are diagrams for explaining a method of extracting the pixel data input to the filter calculation circuit. FIGS. 8A and 8B are timing charts illustrating operations of the image processing circuit at every one clock.

As described above, in the block memory 112, the pixel data corresponding to one segment which is input to the filter calculation circuit 120 and the filter calculation target are located in one segment (FIG. 4A and FIG. 7A) or located over two segments (FIGS. 4B and 4C and FIGS. 7B and 7C). In addition, the pixel data has no choice but to be read in a segment unit at one time (at one clock) from the block memory 112. For that reason, when the pixel data as the filter calculation target are located over two segments, it is necessary to make a study of not decreasing a processing speed. Accordingly, the image processing circuit 110 is provided with the register 114. Hereinafter, details will be described.

First, the case (FIG. 4A and FIG. 7A) where the pixel data to be input to the multipliers 122 of the filter calculation circuit 120 are located in one segment will be described with reference to the timing chart of FIG. 8A. In this case, the registers 114R, 114G, and 114B are not used. In addition, FIG. 8A shows that the output pixel data of the notice pixel 1 is obtained by performing the filter calculation.

In the image processing circuit 110, the filter calculation circuit 120 is shared for the RGB colors. Therefore, as shown in FIG. 8A, the same operation is performed for each of the RGB colors at later timing by one clock by the control of the selector 118. Here, the description will be made focusing on the R color.

(1) At First Clock: in order to read the pixel data of the segment 0 (L0), addresses of the pixel data are set to the block memory 112R.

(2) At Second Clock: the pixel data of the segment 0 (L0) are read from the block memory 112R, and then each pixel data is input to the multipliers 122 through the selector 116R. Simultaneously, in order to read the pixel data of the segment 0 (L0), the addresses of the pixel data are set to the block memory 112G.

By repeatedly performing the processes (1) and (2), the pixel data of the segment 4 (L1), the segment 8 (L2), the segment 12 (L3), and the segment 16 (L4) are input to the multipliers 122. That is, at the total five clocks, the pixel data corresponding to five segments are input to the multipliers 122 to obtain the output pixel data of the notice pixel 1. For the entire RGB colors, total fifteen clocks are necessary. In addition, when a clock necessary for setting an address is added, the total sixteen clocks are used. Likewise, the filter calculation on the notice pixels 2 to 8 is performed by reading each segment during the shifting by four pixels in the sub-scanning direction.

Next, the case (FIGS. 7B and 7C) where the pixel data as the filter calculation target are located over two segments will be described with reference to the timing chart of FIG. 8B. In this case, the registers 114R, 114G, and 114B are used. In addition, FIG. 8B shows that the output pixel data of the notice pixel 9 is obtained by performing the filter calculation. Details will be descried focusing on the R color likewise.

(1) At First Clock: in order to read the pixel data of the segment 1 (L0), addresses of the pixel data are set to the block memory 112R.

(2) At Second Clock: the pixel data of the segment 1 (L0) are read, and then each pixel data is stored in the register 114R (in addition, each pixel data is stored in the register from a clock subsequent to a clock at which the reading is possible in the drawing). Simultaneously, in order to read the pixel data of the segment 0 (L0), the addresses of the pixel data are set to the block memory 112R.

(3) At Third Clock: the pixel data of the segment 1 (L0) stored in the register 114R and the pixel data of the segment 0 (L0) on the block memory 112R are read. Subsequently, the selector 116R extracts the pixel data output to the multipliers 122 among the read pixel data. Subsequently, the pixel data are arranged at locations corresponding to the pixel locations in the filter and input to the multipliers 122. Here, four pixel data (main scanning locations 1 to 4, sub-scanning location 0) of the segment 0 (L0) and one pixel data (main scanning location 0, sub-scanning location 1) of the segment 1 (L0) are extracted, and the pixel data of the segment 1 (L0) is arranged after the pixel data of the segment 0 (L0) to be input to the multipliers 122.

By repeatedly performing the processes (1) to (3), the pixel data of the segments 4 and 5 (L1), the segments 8 and 9 (L2), the segments 12 and 13 (L3), and the segments 16 and 17 (L4) are read and the pixel data corresponding to one segment are extracted to be input to the multipliers 122. That is, at the total five clocks, the pixel data corresponding to five segments are input to the multipliers 122 to obtain the output pixel data of the notice pixel 9. For the entire RGB colors, total fifteen clocks are necessary. In addition, when a clock necessary for setting an address is added, the total seventeen clocks are used. Likewise, the filter calculation on the notice pixels 9 to 16 is performed by reading each segment during the shifting by four pixels in the sub-scanning direction. In addition, the same is applied to a case of FIG. 7C.

In this way, the image processing circuit 110 is capable of performing the filter calculation without decreasing the processing speed even when the pixel data to be input to the multipliers 122 are located in one segment and even when the pixel data to be input to the multipliers 122 are located over two segment.

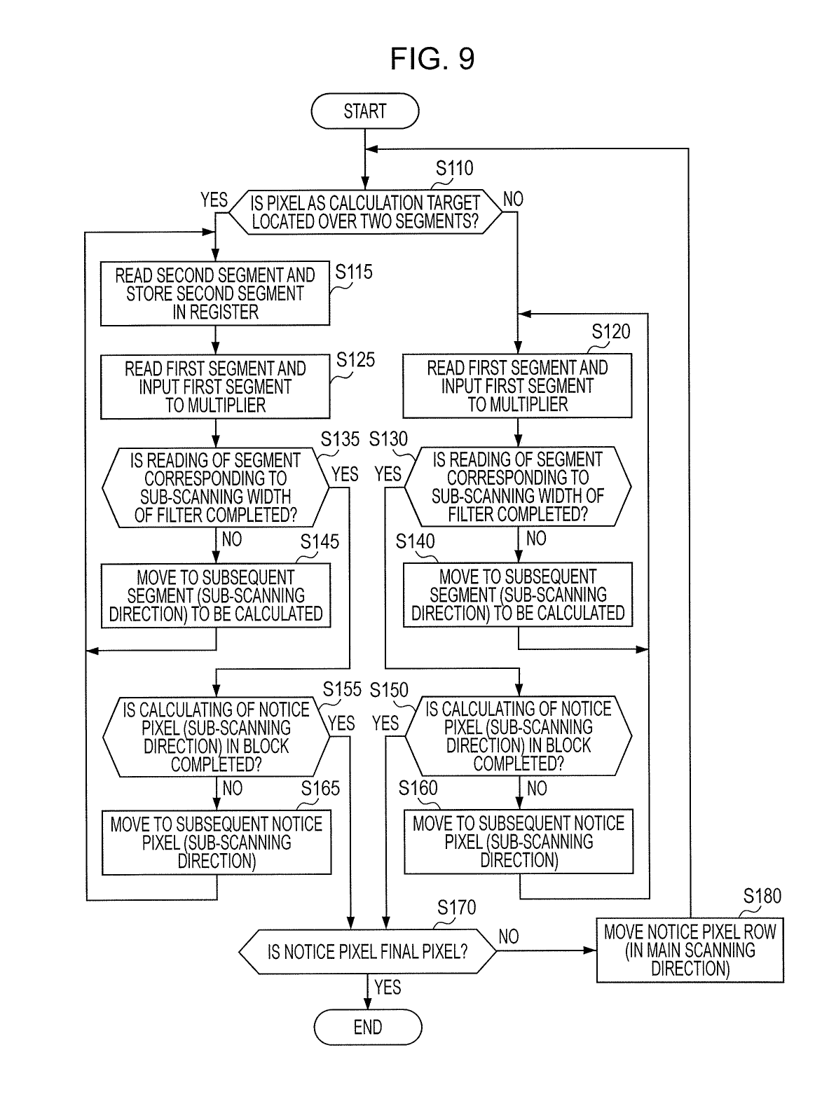

Next, a flow of the block process by the image processing circuit 110 will be described. FIG. 9 is a flowchart illustrating the flow of the block process. For easy description, the block process is performed on one of the RGB colors.

When the pixel data of the image memory 100 are copied to the block memory 112 in the above-described manner, the flow of the block process is started. In addition, each pixel data to be used in the later filter calculation process is copied to the segment subjected to the filter calculation process from the image memory 100 and stored in advance.

First, it is determined whether the pixel data as the filter calculation target are located over two segments (S110). When the pixel data are not located over two segments (No in S110), processes of S120 to S160 are performed. Alternatively, when the pixel data are located over two segments (Yes in S110), processes of S115 to S165 are performed.

In S120, the segment to be calculated is first read from the block memory 112 and input to the multipliers 122 of the filter calculation circuit 120 through the selector 116 (S120).

Subsequently, it is determined whether reading of the segment corresponding to the sub-scanning width m of the filter is completed (S130). When it is determined that the reading is not completed (No in S130), the process proceeds to S140. Alternatively, when it is determined that the reading is completed (Yes in S130), the process proceeds to S150.

When it is determined that the reading is not completed (No in S130), the segment to be calculated is changed into a subsequent segment (S140). Then, the process returns to S120.

Alternatively, when it is determined that the reading is completed (Yes in S130), it is determined whether calculating of the final notice pixel in the notice pixel row in the sub-scanning direction is completed (S150). When it is determined that the calculating is not completed (No in S150), the process proceeds to S160. Alternatively, when it is determined that the calculating is completed (Yes in S150), the process proceeds to S170.

When it is determined that the calculating is not completed (No in S150), the filter location is changed into the subsequent notice pixel in the sub-scanning direction (S160). Then, the process returns to S120.

Alternatively, when it is determined that the calculating is completed (Yes in S150), it is determined whether the notice pixel which is a final calculation target is a final pixel (S170). In addition, the final pixel refers to a pixel which is located at an intersection between an end row and an end column of the area 14 (see FIG. 1). When it is determined that the notice pixel is not the final pixel (No in S170), the process proceeds to S180. Alternatively, when it is determined that the notice pixel is the final pixel (Yes in S170), the process ends.

When it is determined that the notice pixel is not the final pixel (No in S170), the notice pixel row is moved to a row adjacent to the notice pixel row in the main scanning direction by one row (S180), and then the process returns to S110.

Alternatively, when it is determined that the notice pixel is the final pixel (Yes in S170), the process ends. In addition, when the block process is performed on an area 14 (see FIG. 1) subsequent to the processed area 14, the flow of the block process is again started.

In S115, the second segment between two segments containing the pixel data as the filter calculation target is first read from the block memory 112 and stored in the register 114 (S115).

Subsequently, the pixel data stored in the register 114 in S115 and the first segment between the two segments containing the pixel data as the filter calculation target are read from the block memory 112. In addition, the selector 116 extracts the pixel data input to the multipliers 122 among the read pixel data, and then the extracted pixel data are arranged in order corresponding to the filter to be input to the multipliers 122 of the filter calculation circuit 120 (S125).

Description of S135 to S165, S170, and S180 are omitted, since the processes of S135 to S165, S170, and S180 are the same as those of S130 to S160, S170, and S180 described above.

The first embodiment has been described. According to this embodiment, the power consumption and the circuit size of the image processing circuit capable of performing the block process can be reduced and the filter calculation speed is able to be performed at a high speed. That is, by using the SRAM as the block memory, it is possible to realize the image processing circuit having low power consumption and a small circuit size. Moreover, by sharing the multipliers provided in correspondence with the main scanning width for the RGB colors and providing the registers between the block memory and the multipliers, the processing speed is substantially not dropped, compared to a case of one time access, even when all the pixel data as the filter processing target cannot be read from the block memory by one time access.

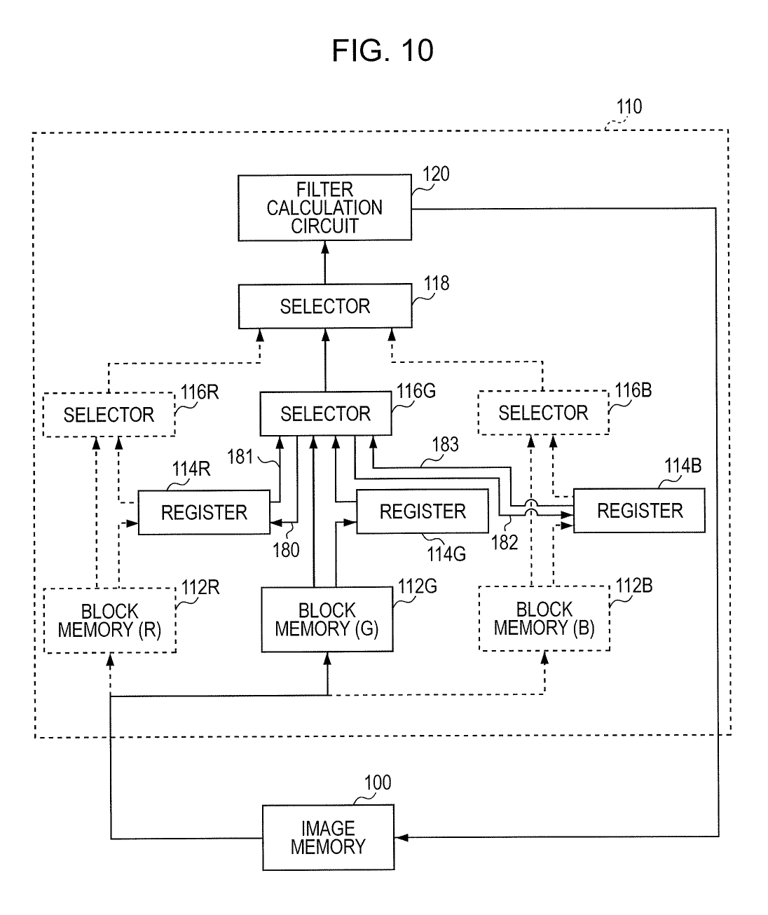

Next, a second embodiment of the invention will be described with reference to the drawings. In the second embodiment, the circuit configuration used for the filter calculation of a color image in the first embodiment can be used. However, the circuit configuration is used not only for the filter calculation of the color image but also for the filter calculation of a monochrome image. Moreover, the circuit configuration is designed to realize the filter calculation of a monochrome image at a high speed. In an image processing circuit according to this embodiment, a circuit indicated by a solid line shown in FIG. 10 is switched for an operation upon processing a monochrome image and the circuit indicated by a solid line shown in FIG. 5 is switched for an operation upon processing a color image. Hereinafter, different points different from those in the first embodiment will be described when the filter calculation of a monochrome image is performed.

FIG. 10 is a block diagram illustrating the overall configuration of the image processing circuit according to this embodiment. In this embodiment, one of the block memories 112 provided for the RGB colors is used as a memory which stores the block image of an original monochrome image. Here, the circuit configuration using the block memory 112G of the G color is used.

As shown in the drawing, this embodiment is different from the first embodiment in that the selector 116G is connected to other registers 114R and 114B through signal wires 180 to 183.

As in the first embodiment, the register 114G is used when the pixel data as the filter calculation target are located over two segments. On the other hand, the registers 114R and 114B are used to store a copy of the pixel data corresponding to one segment output to the filter calculation circuit 120 by the selector 116G.

The signal wires 180 and 182 are used to store the copy of the pixel data output to the filter calculation circuit 120 by the selector 116G to the registers 114R and 114B, respectively. In addition, the signal wires 181 and 183 are used for the selector 116G to read the pixel data stored in the registers 114R and 114B, respectively, in order to output the read pixel data to the filter calculation circuit 120. In addition, in the filter calculation circuit 120, the register 134G is used, but the registers 134R and 134B are not used.

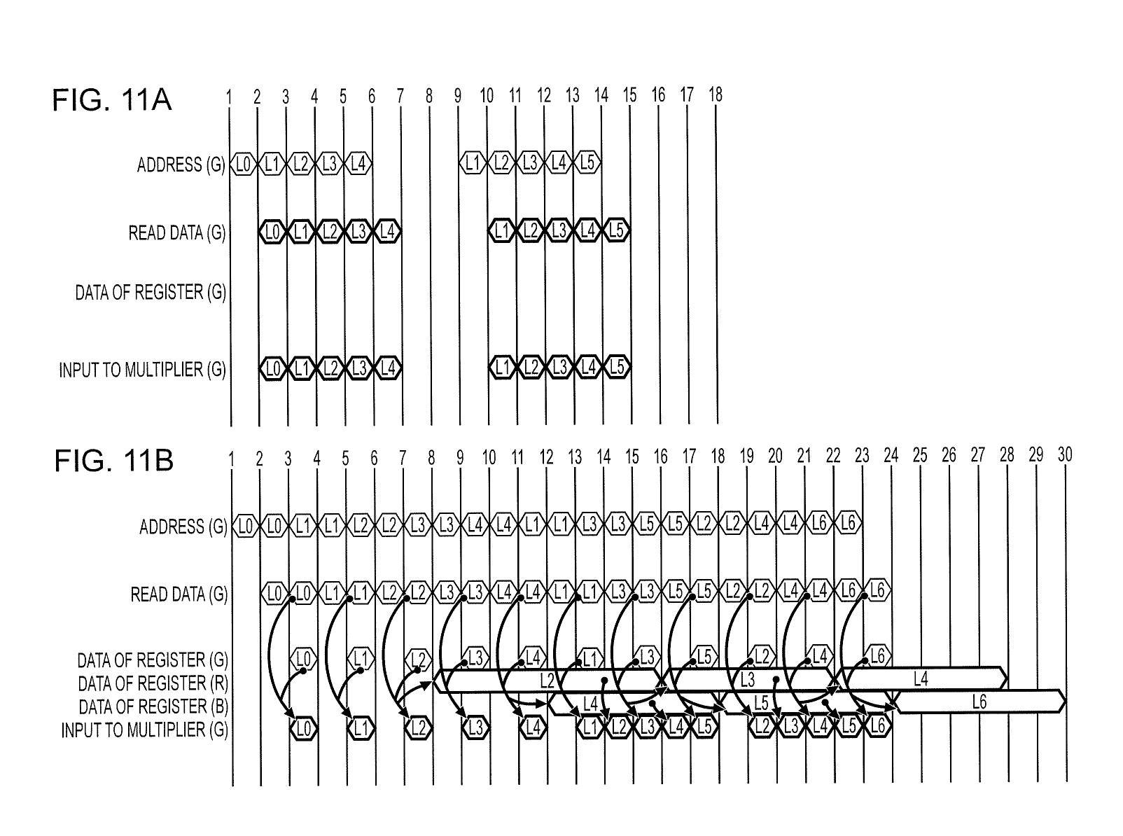

Next, characteristic operations of the image processing circuit 110 will be described with reference to FIGS. 4A to 4C, 7A to 7C, and 11A and 11B. FIGS. 11A and 11B are timing charts illustrating operations of the image processing circuit at every one clock.

First, a case (FIG. 4A and FIG. 7A) where the pixel data to be input to the multipliers 122 of the filter calculation circuit 120 are located in one segment will be described with reference to the timing chart of FIG. 11A. In this case, the registers 114R, 114G, and 114B are not used. FIG. 11A shows that the output pixel data of notice pixels 1 and 2 are obtained by performing the filter calculation. Since the original image is monochrome, a monochrome process is performed.

(1) At First Clock: in order to read the pixel data of the segment 0 (L0), addresses of the pixel data are set to the block memory 112G.

(2) At Second Clock: the pixel data of the segment 0 (L0) are read from the block memory 112G, and then each pixel data is input to the multipliers 122 through the selector 116G. Simultaneously, in order to read the pixel data of the segment 4 (L1), the addresses of the pixel data are set to the block memory 112G.

By repeatedly performing the processes (1) and (2), the pixel data of the segment 4 (L1), the segment 8 (L2), the segment 12 (L3), and the segment 16 (L4) are input to the multipliers 122. That is, at the total five clocks, the pixel data corresponding to five segments are input to the multipliers 122 to obtain the output pixel data of the notice pixel 1. In addition, when a clock necessary for setting an address is added, the total six clocks are used. Likewise, the filter calculation on the notice pixels 2 to 8 is performed by reading each segment during the shifting by four pixels in the sub-scanning direction.

Next, the case (FIGS. 7B) where the pixel data as the filter calculation target are located over two segments will be described with reference to the timing chart of FIG. 11B. In this case, the register 114G is used as in the first embodiment. The registers 114R and 114B are used to store a copy of the pixel data corresponding to one segment output to the filter calculation circuit 120 by the selector 116G. In addition, FIG. 11B shows that the output pixel data of the notice pixels 9 to 11 are obtained.

(1) At First Clock: in order to read the pixel data of the segment 1 (L0), addresses of the pixel data are set to the block memory 112G.

(2) At Second Clock: the pixel data of the segment 1 (L0) are read, and then each pixel data is stored in the register 114G (in addition, each pixel data is stored in the register from a clock subsequent to a clock at which the reading is possible in the drawing). Simultaneously, in order to read the pixel data of the segment 0 (L0), the addresses of the pixel data are set to the block memory 112G.

(3) At Third Clock: the pixel data of the segment 1 (L0) stored in the register 114G and the pixel data of the segment 0 (L0) on the block memory 112G are read. Subsequently, the selector 116G extracts the pixel data input to the multipliers 122 among the read pixel data. Subsequently, the pixel data are arranged at locations corresponding to the pixel locations in the filter and input to the multipliers 122. Here, four pixel data (main scanning locations 1 to 4, sub-scanning location 0) of the segment 0 (L0) and one pixel data (main scanning location 0, sub-scanning location 1) of the segment 1 (L0) are extracted, and the pixel data of the segment 1 (L0) is arranged after the pixel data of the segment 0 (L0) to be input to the multipliers 122. Simultaneously with this operation, addresses of the pixel data of the segment 5 (L1) are set to the block memory 112G in order to read the pixel data of the segment 5 (L1).

(4) At Fourth to Eleventh Clocks: by repeatedly performing the processes (1) and (3), the pixel data of the segments 4 and 5 (L1), the segments 8 and 9 (L2), the segments 12 and 13 (L3), and the segments 16 and 17 (L4) are read and the pixel data corresponding to one segment are extracted to be input to the multipliers 122. Additionally, a process described below is performed at a seventh clock and an eleventh clock. The pixel data corresponding the one segment read and selected from the registers 114G and the block memory 112G by the selector 116G are input to the multipliers 122, and the pixel data are simultaneously stored in the register 114R or 114B through the signal wire 180 or 182. Here, the pixel data of L2 are stored in the register 114R at the seventh clock, and the pixel data of L4 are stored in the register 114B at the eleventh clock (in addition, each pixel data is stored in the register from a clock subsequent to a clock at which the reading is possible in the drawing). When the output pixel data of the subsequent notice pixel (notice pixel 10) is obtained, the pixel data are read to be output to the filter calculation circuit 120 for use. That is, it is possible to output the pixel data to the filter calculation circuit 120 without access to the block memory 114G. In this way, at the total five clocks, the pixel data corresponding to five segments are input to the multipliers 122 to obtain the output pixel data of the notice pixel 9. In addition, when a clock necessary for setting an address is added, the total eleven clocks are used.

(5) At Eleventh to Seventeenth Clocks: the processes of (1) to (4) are repeatedly performed. However, the pixel data stored in the registers 114R and 114B are read through the signal lines 181 and 183, respectively, and output to the filter calculation circuit 120 without access to the block memory 114G. Here, the pixel data of L2 are read from the register 114R at a fourteenth clock to be input to the multipliers 122 and the pixel data of L4 are from the register 114B at a sixteenth clock to be input to the multipliers 122. That is, the pixel data read from the registers 114R and 114B are output at timing at which the multipliers 122 are not used. In addition, at fifteenth and seventeenth clocks, the pixel data of L3 and L5 to be used for the filter calculation of a subsequent notice pixel (notice pixel 11) are stored in the registers 114R and 114B, respectively. In this way, at the total five clocks, the pixel data corresponding to five segments are input to the multipliers 122 to obtain the output pixel data of the notice pixel 10. In addition, when a clock necessary for setting an address is added, the total seven clocks are used. The same is applied to subsequent notice pixels.

The second embodiment has been described. According to this embodiment, the same advantages as those in the first embodiment are obtained for a color image. Moreover, by using the register provided between the block memory and the multipliers and used for the filter calculation on other two colors, the processing speed is substantially not slow, compared to a case of one time access, even when all the pixel data as the filter processing target cannot be read from the block memory by one time access.

As described above, the exemplary embodiments of the invention have been described. It should be apparent that numerous substitutions, amendments, modifications can be made for a person skilled in the art. Accordingly, the above-described embodiments of the invention are just examples of the gist and scope of the invention, but not considered as limiting.

What is claimed is:

1. An image processing system capable of performing filter calculation on an image, comprising:
an image memory configured to store an original image having a width and a length;
a scanning area, having rows and columns of pixels, in the image memory containing pixels necessary to perform filter calculation, wherein the scanning area has a scanning width equal to the width of the original image and a sub-scanning width less than the length of the original image;
a filter having a horizontal scanning width and a vertical sub-scanning width and configured to select pixels from the scanning area for filter calculation; and
an image processing circuit configured to process pixels selected by the filter to form processed pixels, and further configured to store the processed pixels in the image memory.

2. The image processing system of claim 1, wherein the image processing circuit further comprises:
a first block memory for a color red of RGB color model coupled to the image memory;
a second block memory for a color green of RGB color model coupled to the image memory;
a third block memory for a color blue of RGB color model coupled to the image memory;
a first selector coupled to the first block memory;
a second selector coupled to the second block memory;
a third selector coupled to the third block memory;
a first register coupled to the first block memory and the first selector;
a second register coupled to the second block memory and the second selector;
a third register coupled to the third block memory and the third selector;
a fourth selector coupled to the first selector, the second selector and the third selector; and
a filter calculation circuit coupled to the fourth selector and the image memory; wherein said pixels from the scanning area are stored in the first, second and the third block memories and transferred to the filter calculation circuit from the fourth selector.

3. The image processing system of claim 1, wherein the filter calculation is performed on a part of the scanning area having a scanning width equal to the scanning width of the scanning area and a sub-scanning width that is spaced from the sub-scanning width of the scanning area by distance D from the top and bottom of the sub-scanning width.

4. The image processing system of claim 1, wherein the pixels are processed in the sub-scanning direction in the scanning area until the last row is reached prior to initiating the processing from the next adjacent column of pixels.

5. The image processing system of claim 1, wherein the scanning area moves along the length of the original image to cover the entire area of the image.

6. The image processing system of claim 1, wherein the filter further includes a notice pixel located at the center of the filter such that there are equal number of pixels on top, bottom, left and right of the notice pixel in the filter.

7. The image processing circuit of claim 2, wherein each of the first, second and third block memories is configured to store pixel data having a bit width that is at least equal to scanning width of the filter, and has a storage capacity at least double of sub-scanning width of the scanning area.

8. The image processing circuit of claim 7, wherein the pixels in the scanning area are stored in the block memories in a form of segments of pixels such that the size of each segment is equal to the bit width of the block memory.

9. An image processing system capable of performing filter calculation on an image, comprising:
an image memory configured to store an original image having a width and a length;
a scanning area, having rows and columns of pixels, in the image memory containing pixels necessary to perform filer calculation, wherein the scanning area has a scanning width equal to the width of the original image and a sub-scanning width less than the length of the original image;
a filter having a horizontal scanning width and a vertical sub-scanning width and configured to select pixels from the scanning area for filter calculation; and
an image processing circuit configured to process pixels selected by the filter to form processed pixels, and further configured to store the processed pixels in the image memory, wherein the image processing circuit is further configured to switch to an operation mode for processing monochrome images such that only elements that are necessary for processing a monochrome image are used.

10. The image processing system of claim 9, wherein the image processing circuit further comprises:
a first block memory for a color red of RGB color model coupled to the image memory;
a second block memory for a color green of RGB color model coupled to the image memory;
a third block memory for a color blue of RGB color model coupled to the image memory;
a first selector coupled to the first block memory;
a second selector coupled to the second block memory;
a third selector coupled to the third block memory;
a first register coupled to the first block memory, the first selector and the second selector;
a second register coupled to the second block memory and the second selector;
a third register coupled to the third block memory, the third selector and the second selector;
a fourth selector coupled to the first selector, the second selector and the third selector; and
a filter calculation circuit coupled to the fourth selector and the image memory; wherein said pixels from the scanning area are stored in the first, second and the third block memories and transferred to the filter calculation circuit from the fourth selector, and wherein the image processing circuit is switched to use only one block memory and the selector coupled to that block memory, the fourth selector, the filter calculation circuit and all of the registers when the circuit is processing a monochrome image.

11. The image processing circuit of claim 10, wherein the first register and the second register are used in addition to the third register when the circuit is processing a monochrome image such that the first and the second register increase the processing speed of the image processing circuit by providing the image processing circuit with the ability to retain more data segments.

12. The image processing system of claim 9, wherein the filter calculation is performed on part of the scanning area having a scanning width equal to the scanning width of the scanning area and a sub-scanning width that is spaced from the sub-scanning width of the scanning area by distance D from top and bottom of the sub-scanning width.

13. The image processing system of claim 9, wherein the pixels are processed in the sub-scanning direction in the scanning area until the last row is reached prior to initiating the processing from the next adjacent column of pixels.

14. The image processing system of claim 9, wherein the scanning area moves along the length of the original image to cover the entire area of the image.

15. The image processing system of claim 9, wherein the filter further includes a notice pixel located at the center of the filter such that there are equal number of pixels on top, bottom, left and right of the notice pixel in the filter.

16. The image processing circuit of claim 10, wherein each of the block memories is configured to store pixel data having a bit width that is at least equal to scanning width of the filter, and has a storage capacity at least double of sub-scanning width of the scanning area.

17. The image processing circuit of claim 16, wherein the pixels in the scanning area are stored in the block memories in form of segments of pixels such that the size of each segment is equal to the bit width of the block memory.

18. A method for performing filter calculation on an image, comprising:
designating a scanning area, having rows and columns of pixel data, in an original image stored in an image memory;
using a filter, transferring pixel data from the scanning area to an image processing circuit by selecting the pixels in vertical direction from top to bottom until the last row of the scanning area is reached and continuing with the next adjacent column of pixels;
storing the pixel data transferred to the image processing circuit in block memories for each of colors in the RGB color model, such that the pixel data are stored in the block memories in form of segments of pixels;
selecting the stored segments from the block memories with selectors coupled to the block memories for each color of RGB color model and transferring the segment into a filter calculation circuit; and
using multipliers, multiplying each of pixel data received from selectors by a filter coefficient input, and using adders, adding each of the multiplied result to the result provided by a register group, wherein there are multiple register groups corresponding to the number of adders;
using an adder, adding the results provided by each of the register groups and transferring the result to a divider.

19. The method of claim 18, wherein the scanning area moves along the length of the original image to cover the entire area of the image.

20. The method of claim 18, wherein the filter further includes a notice pixel located at the center of the filter such that there are equal number of pixels on top, bottom, left and right of the notice pixel in the filter.

21. The method of claim 18, further comprising:
coupling each of block memories and its corresponding selector to a register configured to retain a segment of pixels when the pixel data required to perform filter calculation is spread among two segments; and
configuring the selectors to select the pixels necessary for filter calculation from the segments stored in the block memory and the register.

22. The method of claim 21, further comprising:
connecting each of the registers to a same selector for one of the colors in the RGB color model in addition to connecting the registers to their corresponding selector; and
switching the circuit to use only elements necessary for processing one of the colors in the RGB color model when a monochrome image is being processed, wherein the registers are used to retain additional segments and improve the processing speed.
